(19) United States
(12) Patent Application Publication
(10) Pub. No.: US 2009/0259565 A1
(43) Pub. Date: Oct. 15, 2009

(54) SYSTEM AND METHOD FOR PROVIDING MOVING AND TRANSPORT SERVICE LEADS

(76) Inventors: Yossef Avisror, West Newton, MA (US); Eli Shalem, Oakland Park, FL (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/415,645

(22) Filed: Mar. 31, 2009

Related U.S. Application Data
(60) Provisional application No. 61/041,761, filed on Apr. 2, 2008.

(51) Int. Cl. G06Q 30/00; G06F 15/16; G06Q 99/00; G06Q 50/00; G06F 17/30; G06F 17/40

(52) U.S. Cl. 705/26; 709/204; 705/1; 707/3

(57) ABSTRACT

Moving and transportation leads are provided by receiving customer data from a customer interface coupled to a communications network, the data comprising information related to a request for moving services; matching the customer data with moving and transport service capabilities stored in a user profile; providing notification to a user account associated with a moving an transport company having the associated matching data of a customer lead.

### CROSS-REFERENCE TO RELATED APPLICATION

This application claims the benefit under 35 U.S.C. § 119(e) to U.S. Application No. 60/041,761, titled “System and Method for Providing Moving and Transport Service Leads” and filed on Apr. 2, 2008, which is hereby incorporated by reference herein in its entirety.

### FIELD OF THE INVENTION

The present invention provides a system and method for providing service leads in the moving and transport industry.

### BACKGROUND

Mortgage brokers provide various moving and transportation companies, typically for a fee, the names and addresses of a person or business needing professional moving assistance. Lead information conveyed by the mortgage broker is generally conveyed to moving companies via a third party that sends the moving company lead information over the Internet, e.g., using an e-mail notification. Leads may also be provided over the phone or in periodic, written communications. When a moving company contracts with a mortgage broker to receive leads from a third party, the moving company may designate an area in which the customer leads are located, but other details are not designated. As a result, moving companies may receive leads that are not relevant to their moving business. For example, a moving company may receive a lead having a required moving date, but the moving company may not have any schedule openings during the required time. In another example, a moving company may not have certain moving capacities or moving capabilities, e.g., for transporting a car, boat, camper, etc., but because the moving company cannot indicate their capabilities and limits, leads requiring transport of a vehicle may be sent to the moving company. Accordingly, the current methods of providing customer leads to moving companies are not cost effective and are inefficient for developing customers. Thus, there is a need in the industry for providing lead information to moving and transportation companies that is more efficient, relevant and streamlined.

### SUMMARY

Various embodiments of the invention address the issues described above by providing a system and method for providing relevant customer leads to moving and transport companies.

According to one embodiment, a method for providing a moving and transportation lead to a moving and transportation company in a communications network includes receiving customer data from a customer interface coupled to the communications network, the data comprising information related to a request for moving services; matching the customer data with moving and transport service capabilities stored in a user profile; providing notification to a user account having the associated matching data of a customer lead.

In one implementation, a system for providing a moving and transportation lead to a moving and transportation company includes a customer database for receiving customer data from a customer interface coupled to a communication network, the data comprising information related to a request for moving services; a user database coupled to the communication network for receiving and storing user profile data; a database management system coupled to the communication network for comparing and matching the customer data with moving and transport service capabilities stored in the user profile; and a leads/orders database coupled to the communication network for receiving and storing customer lead data and for providing notification to a user account having the associated matching data of a customer lead.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1 is a block diagram of a lead generation system according to certain embodiments.

FIG. 2 is a flowchart of a method for providing a moving and transportation lead according to some embodiments.

FIG. 3 is a flow chart of a method for disseminating a limited number of customer leads to moving companies according to some embodiments.

FIG. 4 is a flow chart of a method for providing moving companies relevant customer leads based on scheduled moving jobs according to certain embodiments.

FIGS. 5-14 are screen shots depicting aspects of embodiments of the present invention.

FIG. 15 is an exemplary computing system for implementing the lead generator according to certain embodiments.

### DETAILED DESCRIPTION

Certain embodiments of the present invention provide a lead system and computer-implemented method on a computer system adapted to execute computer instructions for providing moving and transport leads to moving companies. In certain implementations, the lead system comprises a customer database, a moving company database, a leads/orders database, a network, and a database management system. The lead generation system and method of the present invention are more fully described herein with reference to the figures.

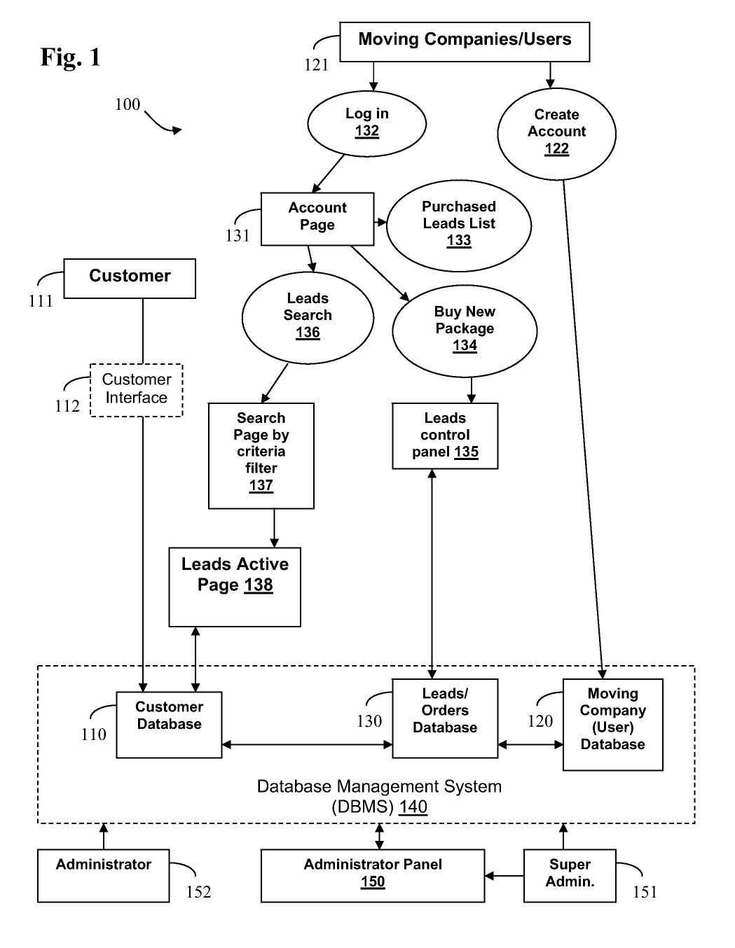

FIG. 1 is a block diagram of a lead generation system 100 according to the present invention. Lead generation system 100 includes customer database 110 with a customer interface 112; moving and transport company database 120 with an account creation page 122; leads/orders database 130 with an account page 131 and associated screens for log in 132, review of previously purchased leads 133, buying new leads packages 134, e.g., via leads control panel 135, searching for leads 136, e.g., via search page 137; database management system 140 encompassing some or a portion of each of customer database 110, moving and transport company database 120, and/or leads/orders database; and administrator panel 150. Various users access lead generation system 100 including customers 111, moving companies 121, super administrators 151 and administrators 152. Lead generation system 100 is thus configured to receive, store, modify and maintain data related to lead generation, and is described more fully in the discussion below.

### Customer Database 110

According to certain embodiments, customer database 110 receives, stores and transmits customer information to lead system 100. A customer 111 (e.g., mortgage broker, an individual moving, or a representative from a company needing assistance moving) may access customer database via a CPU (not shown) connected the Internet, an intranet, a private network, or other suitable networking medium. In a particular embodiment, customer database 110 is accessed by customer 111 via a CPU connected to the Internet.

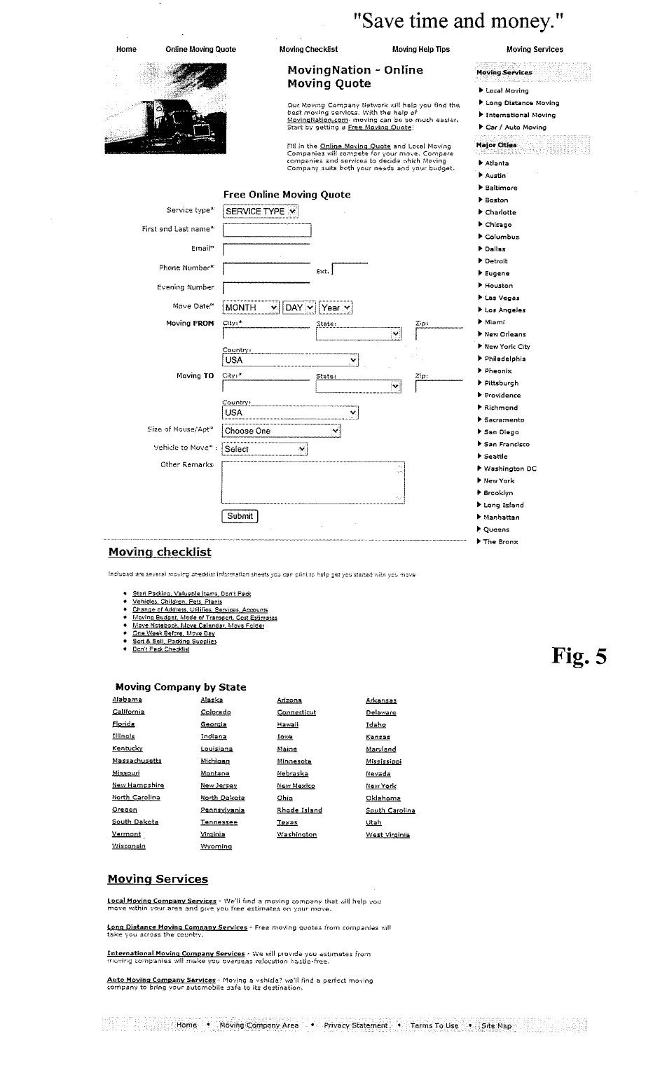

An optional customer interface 112 associated with the lead system 100 provides a means for the customer 111 to enter relevant move information and/or special instructions for the move. FIG. 5 is a screen shot of an exemplary customer interface that may be provided according to certain embodiments. Alternatively, a customer may enter relevant information into customer database 110 directly or by any suitable means. In some implementations, a questionnaire may be provided for customer 111 to complete and may include questions relevant to the customer's move. Relevant move information may include: the name of the person, family or company needing moving assistance, contact information such as e-mail address and phone number, the location, e.g., state, county, zip code, city, street, date from where items are to be retrieved, the destination location for and date which the items are to be dropped-off, and other move associated details. For example, move-related details that may be entered using customer interface include: whether packing and/or unpacking will be performed by the mover, e.g., full packing, custom packing, no packing (packed by owner), the number of heavy items such as pianos, buffets, armoires, or items that may require a Luton body for securing the furniture or a ramp, other articles to be moved, e.g., cars, motorcycles, boats, trailers, campers, or items that may not be considered household goods, the number of rooms or square footage of area needing packing, a distance category, e.g., intrastate less than 50 miles, intrastate more than 50 miles, interstate, international, the type of location where the services will be provided, e.g., apartment, condominium, duplex, townhouse, single family home, business, for both the property of origin and destination, whether the property is owned or rented, the duration in which the property has been occupied, whether an employer is paying for the moving services, whether shuttle service are required, requirement for guaranteed pickup and delivery service (e.g., guaranteed date of pickup and delivery), whether warehouse storage will be used, e.g., storage-in-transit (SIT), and/or valuation of goods to be shipped.

In some instances, if a broker or other party enters data for the party moving into the lead system 100, the customer database 110 may receive and store data on the facilitating party, e.g., name, company, contact information, etc.

Upon entry of the move details into the customer interface 112 or via other entry means, the data is received/collected at customer database 110 and processed by the lead system 100 for subsequent dissemination to moving companies.

### Moving and Transport Company Database 120

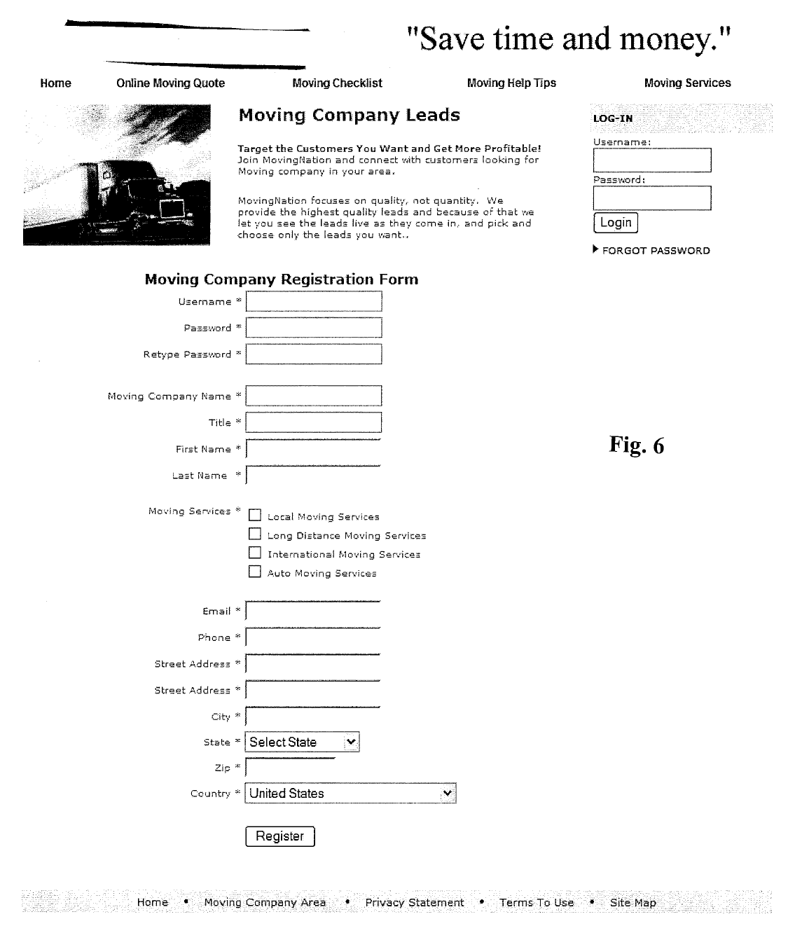

A moving and transport company (MTC) database 120 receives, stores and transmits moving company information to the lead system 100. The MTC database 120 receives data entered by a representative of a moving or transport company 121, and a user account may be established. For example, the representative 121 may access an account creation page 122 associated with MTC database in order to register and open a user account by entering company contact information, company type, e.g., local, interstate, regional and/or international moving, available services, a payment method, and lead product selection. FIG. 6 is a screen shot of an exemplary MTC interface that may be provided according to certain embodiments.

According to some implementations, available services from a transportation and moving company that may be entered into the MTC database 120 may include: packing and/or unpacking, movement of household goods and/or non-household goods (cars, boats), SIT, shuttle, and/or warehouse delivery services. In addition a user account may include information such as affiliations, e.g., registered with the BBB, whether estimates given are binding/non-binding, and/or whether it provides guaranteed pickup and delivery.

### Leads/Orders Database 130

A leads/orders (L/O) database 130 receives, stores and transmits leads/orders to user accounts on lead system 100, e.g., an account associated with a user 121 from a moving or transport company that has created an account using the account creation page 122. For example, in certain configurations, the L/O database 130 stores lead information generated by a database management system (described below) 140 and L/O database 130 provides an initial set of lead information, such as a preview, to a user 121 accessing account page 131. In certain implementations, a lead preview includes the moving parties' general location, e.g., city, state or region, and the type of services requested, e.g., household goods only and/or non-household goods.

Associated with L/O database 130 is user account page 131. User accounts may be accessed via account page 131, and a user 121 may log in 132, review previously purchased leads 133, buy new leads packages 134, e.g., via leads control panel 135, and search for leads 136, e.g., via search page 137 where filter/search criteria may be entered and a search executed.

Purchased leads list 133 provides user 121 with a listing of each of the leads previously selected for purchase. The list may provide details of each lead, or links may be provided on purchased leads list 133 for user to access lead details. In some configurations, user 121 may enter the status of each purchased lead. For example, user 121 may enter that their moving company has contracted to provide moving services to the customer associated with the lead. In another example, a user may enter the status of the moving services are scheduled, in transit or completed. In a further example, user 121 may enter an indication that the moving services were guaranteed by the customer to another moving company.

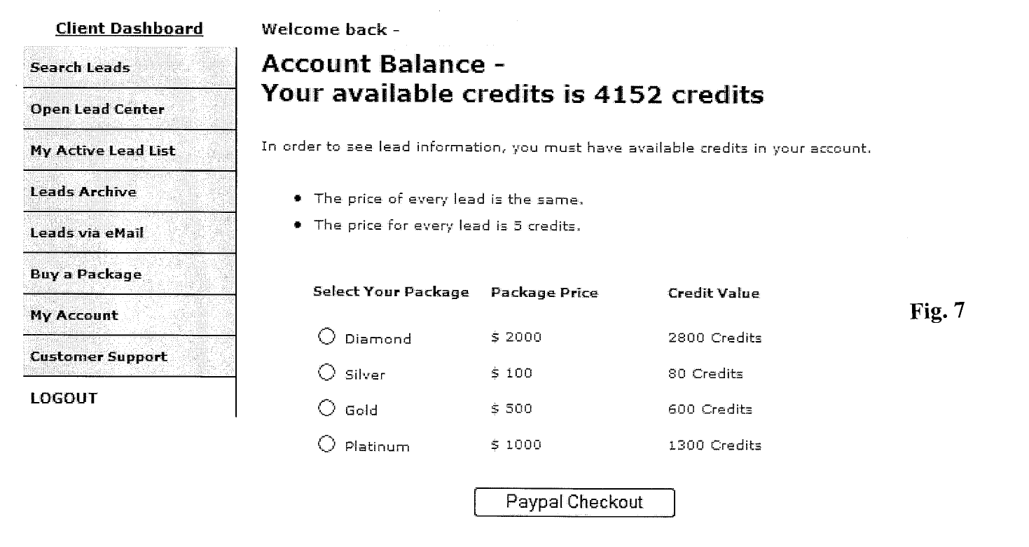

In some implementations, leads control panel 135 is a user interface that may be accessed via account page 131 for user 121 to select one of a number of lead packages. Lead packages selectable at leads control panel 135 may be configured so that a predetermined number of leads are provided in a lead package. Alternatively, a predetermined dollar amount per lead package may allow a user to select a number of leads each with an associated price until the selected dollar amount is consumed. In further configurations, lead packages may for a predetermined time window and expire after a certain time period. Lead packages are discussed further below in relation to administrator panel 150. FIG. 7 is a screen shot of an exemplary account page showing a user's account balance and package options that may be provided according to certain embodiments.

In addition, a payment gateway may also be provided in conjunction leads control panel 135, and the lead generation system 100 may include secure payment user interface screens. In another example, the lead generation system directs a purchaser/user to a secure pay website, such as PayPal.com, where the purchaser enters payment information. When a purchaser is directed to another website for payment purposes, the website may redirect the purchaser back to account page 131 of the lead generation system 100 once payment is confirmed. According to some implementations, the secure payment site may be configured to save the user's credit card information and automatically renew the lead package once the package has been consumed. Automatically renewed packages may be set to renew a predetermined number of times, for example, or may be set to renew until canceled by user 121.

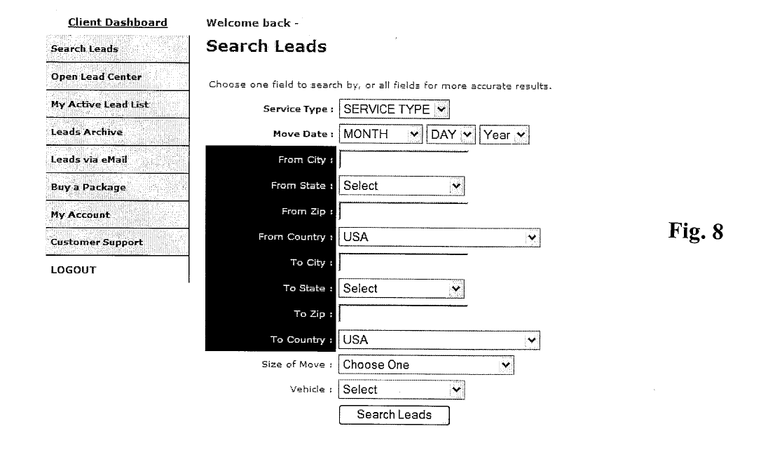

Search page 137 is a user interface that may also be accessed via account page 131 and is for user 121 to search for leads using filter/search criteria. Once a search is executed at search page 137, user 121 may view leads active page 138 where the most current and relevant lead information may be accessed. For example, in some configurations, leads active page 138 is automatically refreshed so that as new leads are entered on the system that match the search criteria entered on search page 137, the user 121 is automatically presented with a preview of the relevant lead(s). In addition, leads active page 138 is automatically refreshed in order to remove sold or expired leads. FIG. 8 is a screen shot of an exemplary leads search page that may be provided according to certain embodiments.

In some implementations, a leads active page 138 may provide a degree of relevance for each lead by a percentage, e.g., 100% being the most relevant or by a star ranking, e.g., * * * * (four stars) being the most relevant. For example, leads in the location entered in search page 137, e.g., Miami, Fla., are highly relevant and may be 100% relevant, whereas leads in Fort Meyers, Fla. are somewhat relevant and may be categorized as 50% relevant. In some implementations, lead generation system 100 automatically categorizes a lead located proximate to the moving companies location as highly relevant. Alternatively, the lead system may not provide a relevance ranking and instead may provide only the most highly relevant leads to a user account, e.g., only those leads matching the search criteria entered in search page 137 or only those leads located within the moving and transportation company's region or state.

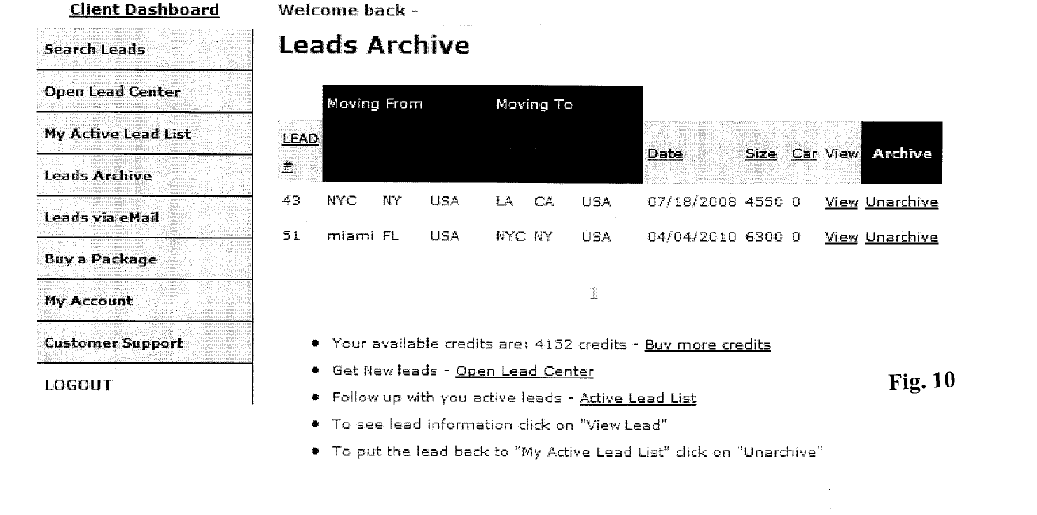

In some implementations, a user may indicate in their user account profile search or filter criteria that would make a lead relevant. For example, filter/search criteria entered in search page 137 may automatically be stored in a user account profile on MTC database 120 and/or L/O database 130 so that when user 121 is not logged on to lead system 100, customer leads matching the entered search criteria may be sent to the user account for user review upon subsequent log in. For example, if over the course of two days from a user's last log in, 10 leads match the search criteria entered by user 121, account page 131 may notify user 121 of the matching leads and provide a link for user 121 to preview the matching leads. In certain implementations, leads may be viewed in an archive page such as the leads archive page provided in FIG. 10, in accordance with certain embodiments.

It will be understood that the various databases described above may be combined into a single database. For example, tables for each of customer, moving company and leads/orders may be stored in a database or other file storage medium.

### Database Management System 140

A database management system (DBMS) 140 comprises software that processes data entered in each of the customer database 110, MTC database 120 and L/O database 130. DBMS 140 may reside separately from the databases, partially in one or all of the databases, or both in a separate location and in the aforementioned one or more databases. In FIG. 1, DBMS 140 resides partially in each of customer database 110, MTC database 120 and L/O database 130. DBMS 140 retrieves and manages data from one or more of the databases. For example, DBMS 140 may modify, edit, delete, and/or process data to generate various results and/or reports.

DBMS 140 receives, sorts and searches customer questionnaire results and matches users 121 (e.g., moving companies) to customers 111 (e.g. party requiring moving services) based on the results. For example, customer information may be sorted based on telephone area code, postal code, city, state and country. DBMS 140 may send results and matches to, for example, the L/O database 130, and users 121 registered in the user database 120 may be granted access to lead information stored therein via account page 131. For example, after new customer located in Boston planning a move to another city in Massachusetts registers with the lead generation system 100, DBMS 140 matches moving company profiles having moving services in Massachusetts, sends the lead information to the L/O database 130 for storage, and user accounts are provided with a notification of the lead. Once a user 121 accesses their account page 131, they may preview the lead stored in L/O database 130, and if selected, be granted access to detailed lead information including the particulars of the customer's move. In some implementations, lead information may be previewed by reviewing the city, state or country the customer is located, and if the moving company is interested in following-up on the lead, the user may select the lead for purchase and viewing lead details.

In some embodiments, a lead notification feature may be provided in connection with DBMS 140, which provides users 121 with e-mail alerts notifying the user that new leads are available for access at the lead generation system. E-mail alerts may be generated upon a new lead being entered in the lead generation system that matches the user's profile. Alternatively, an alert may be generated after the lead generation system identifies 2, 5, 10 or any other suitable number of leads matching the user's profile. The e-mail alert may include a link allowing the user to connect to the lead generation system directly, and the new leads may be viewed at a user interface. In a further embodiment, a user may be alerted of new leads once the user logs on to their account page 131. Other notification features may also be provided by the lead generation system including lead package expiration, consumption, auto-renewal and payment, product, and/or advertising notifications.

### Administrator Panel 150

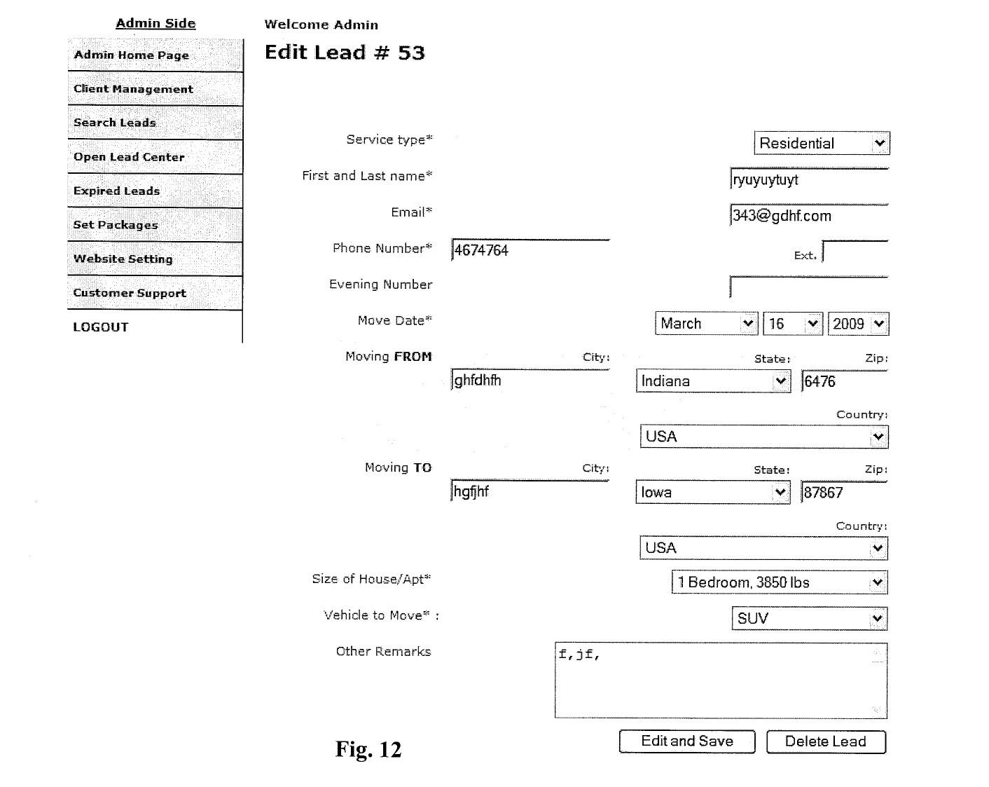

An administrator panel 150 may be provided in conjunction with DBMS 140 and may allow a super administrator 151 to manage information associated with lead system 100. For example, by accessing the administrator panel 150, questionnaires for customers registering with lead system 100 may be created or modified by accessing customer database 110 and modifying the questionnaire. In addition, super administrator 151 may delete leads believed to not be legitimate via administrator panel 150. In another example, reports may be generated using administrator panel 150 and may include sales and/or leads generated for a given period of time and/or location, e.g., city, state, region, and/or per administrator. FIG. 12 is a screen shot of an exemplary edit leads page that may be accessed by an administrator in order to modify leads, which may be provided according to certain embodiments.

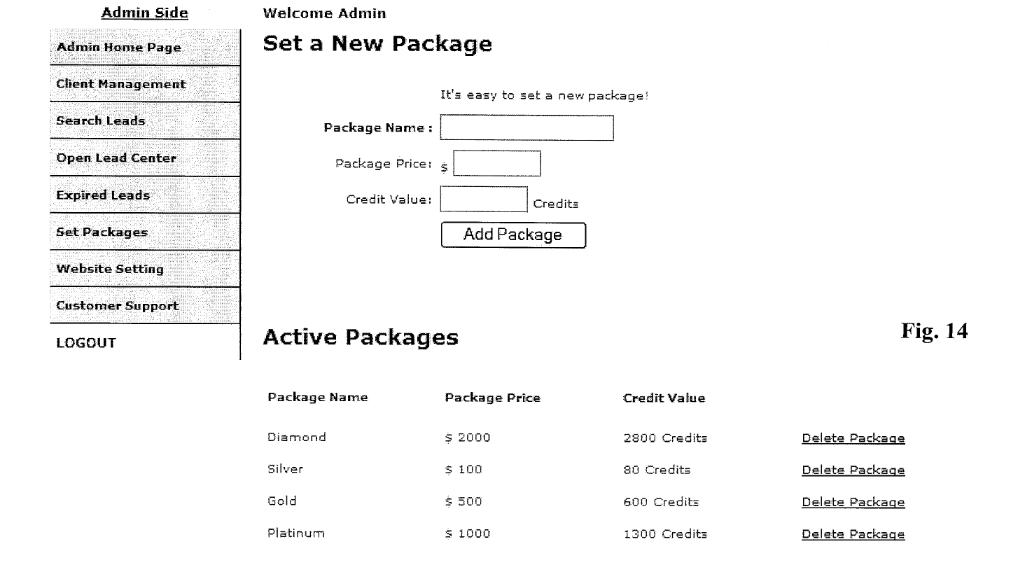

According to certain embodiments, lead generation packages may be defined using the administrator panel 150. For example, a super administrator 151 may define products to be sold to parties interested in purchasing leads. In some configurations, lead packages may be defined according to the number of leads, e.g., 50 leads, or may be defined according to a dollar amount, e.g., $100 for purchasing leads having varying prices. In addition, certain leads may be categorized as premium leads by the super administrator 151 using the administrator panel 150. For example, for a user located in Boston, a lead located in Boston or in Massachusetts may be considered highly relevant and a premium lead. In a further embodiment, lead packages defined narrowly may be categorized as a premium product. For example, users buying a lead package for leads located within a small radius, e.g., 10, 25, 100, 250 miles from the user's base may be a premium package because the user account will be provided with only the most relevant and accessible leads. FIG. 14 is a screen shot of an exemplary package generation page that may be accessed by an administrator in order to modify or create lead packages, which may be provided according to certain embodiments.

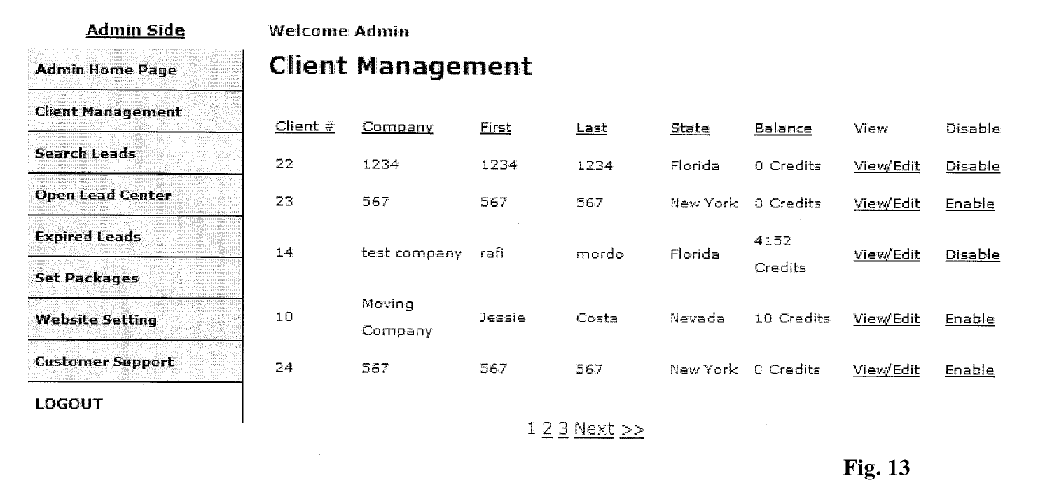

Administrator panel 150 may allow super administrator 151 to manage security levels in DBMS 140 and grant system users access to one or more databases according to their security level. A customer 111 (e.g., party moving or mortgage broker), client/user 121 (e.g., moving company), administrator 152 (e.g., mortgage broker) and super administrator 151 may each have an associated level of security. For example, the level of security may be the highest or most stringent for the customer 111, and the lowest or most accessible for the super administrator 151. FIG. 13 is a screen shot of an exemplary client management page that may be accessed by an administrator in order to view, edit, and enable or disable client accounts, which may be provided according to certain embodiments.

### System Users

Lead generation system 100 may be accessed by customers 111, users 121, administrators 152 and super administrators 151. Super administrators 151 may be provided with the highest security level, meaning the administrator has access to the entire lead generation system and can add, modify, edit and/or delete various components. Super administrator 151 creates administrative users 152 and grants or denies access to the system users. For example, using an administrator panel 150, super administrator 151 may temporarily deny access to an administrator 152, a customer 111 or a user 121. Administrative users 152, e.g., mortgage brokers, may enter customer lead information into customer database 110 using templates. Administrative users, may therefore be a substitute for a consumer that otherwise would not have access to lead generation system 100.

In some embodiments, lead generation system may be configured without a customer interface 112, and instead only administrative users 152 and super administrators 151 may create files with customer information for processing in lead generation system.

Although the above embodiment is of a lead generation system 100 having customer, MTC and L/O and databases, the present invention may be embodied in any number of databases and operate using any management system. In addition, although the above-described databases are described as storing particular data, any of the above databases may hold customer, leads/orders and user data.

### Lead System Operation

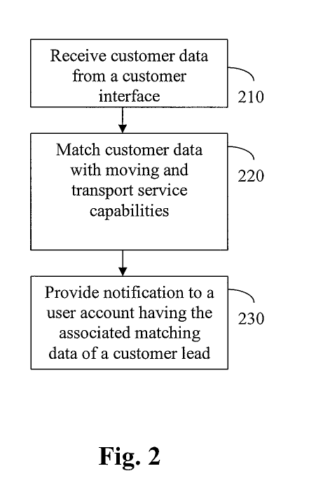

FIG. 2 is a flowchart depicting one method of operation for generating leads according to the present invention. According to FIG. 2, a method for providing a moving and transportation lead to a moving and transportation company in a communication network includes receiving (210) customer data from a customer interface, matching (220) the customer data with moving and transport service capabilities stored in a user profile, and providing (230) notification to a user account having the associated matching data of a customer lead.

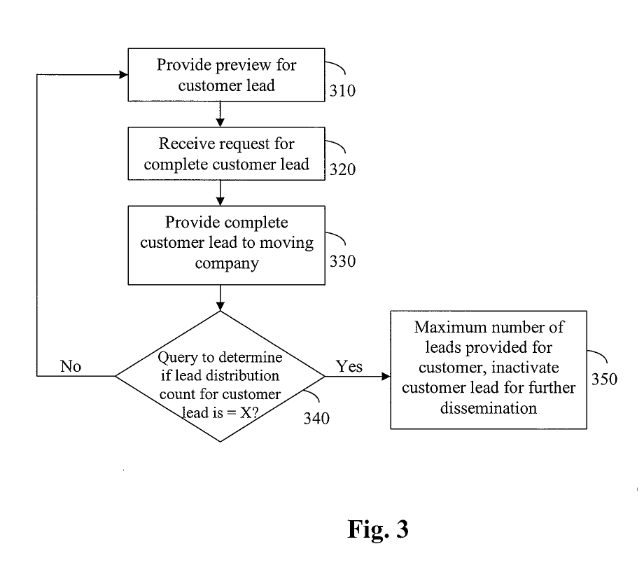

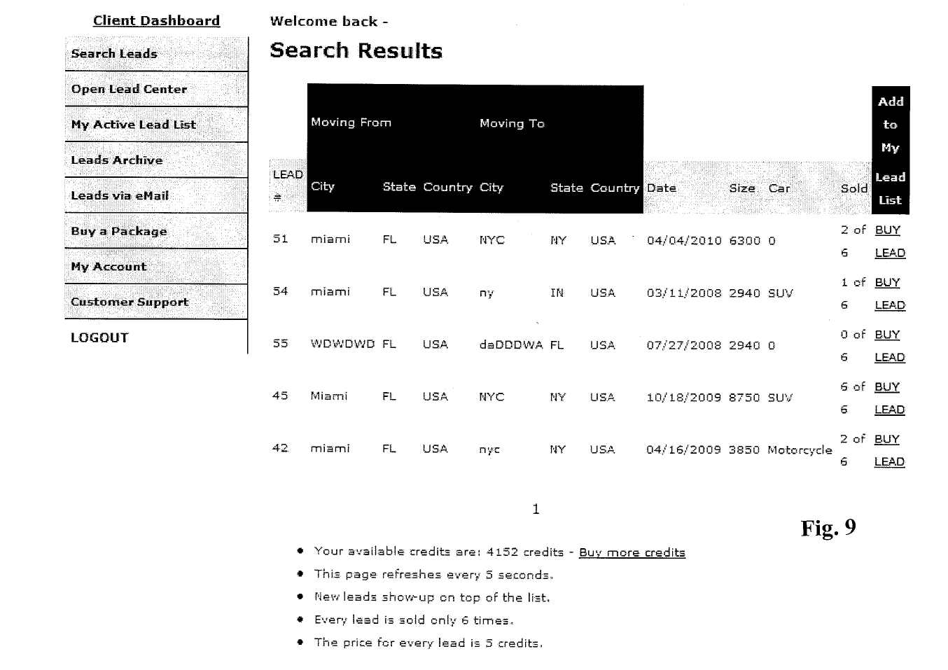

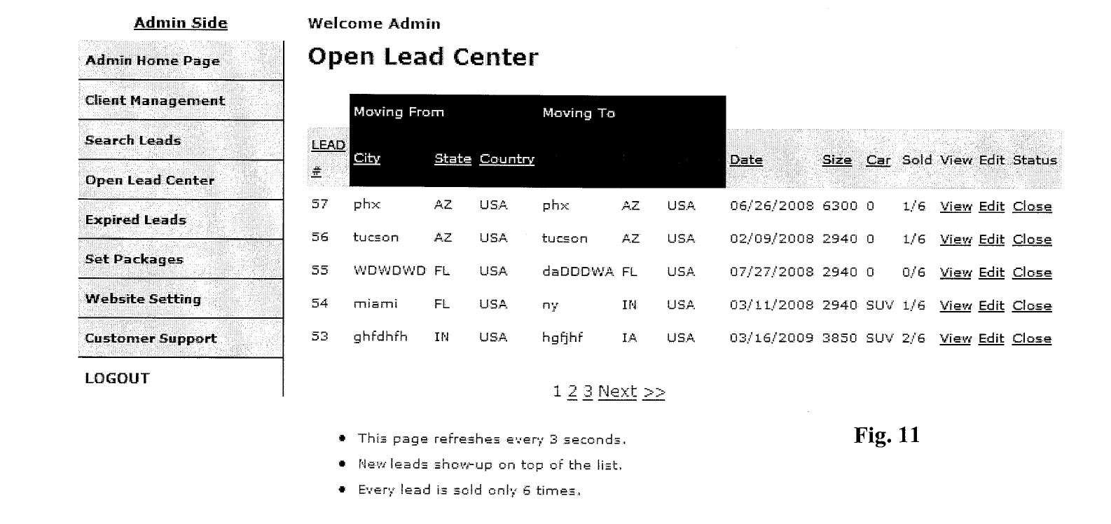

FIG. 3 is a flowchart depicting an aspect of a method of operation of the lead generation system of the present invention. According to FIG. 3, once a user associated with a moving company logs onto lead generation system, they are provided (310) with a preview of a customer lead. The lead may be presented, for example, at account page on a lead line, where additional leads may be provided, each having its own lead line. If the user elects to purchase a lead, lead generation system receives (320) a request for the complete customer lead and provides (330) the lead to the moving company. Once the transaction is complete, the number of times the lead has been distributed is queried (340) to determine whether the number of times the lead has been distributed is equal to X, where X is a predefined number such as 1, 2, 3, 4, 5, 6, 7, 8, 9, 10, 15 or 20. If the number of times the lead has been distributed to users is not equal to X, the lead may be provided to another user and accordingly, the lead preview may be provided (210) to a subsequent lead generation system user. However, where the distribution count for the customer lead is equal to X, the maximum number of customer leads for a particular customer has been distributed and the lead is inactivated (350). Inactive leads are not presented to users upon subsequent log in unless users purchased the lead before it was inactivated. As a result, the lead generation system 100 limits the number of times a customer lead may be distributed. In some implementations, a user previewing a lead may be able to see the number of times a lead has been distributed, e.g., for a lead that has been distributed once and that will be distributed a total of five times, a preview may include 1, 1 of 5, or * on a five star scale. FIG. 9 is a screen shot of an exemplary MTC search results page that provides a user with an indication of how many instances of a lead have been distributed to other customers, e.g., 0, 1, 2 up to 6, and the total instances of leads that may be purchased, e.g., 6, which may be provided according to certain embodiments. FIG. 11 is a screen shot of an exemplary administrator screen that provides an administrator with an indication of how many times each lead has been purchased, e.g., 0, 1, 2, and the total instances of leads that may be purchased, e.g. 6, which may be provided according to certain embodiments. It should be understood that the number of times a lead has been distributed may be provided in any of various user interfaces for any type of user and anywhere in a lead management system, including in a lead preview interface, a lead purchase interface, a leads purchased interface, a leads archive interface, a lead review and edit interface, etc. Furthermore, searching capabilities may be provided that allows a user or administrator the ability to search for leads based, or at least partly based, on the number of times a lead has been distributed. This may provide advantages for an administrator, for example, because they may review multiple leads having the same distribution number, which may help calculate statistics, etc. A user may search for open leads that have been distributed three times or less, for example, in order to be one of the first companies to contact a party associated with a lead.

In certain implementations, each user may purchase a lead only once, and once purchased, the lead may be inactivated or may disappear from account page 131 and instead be viewable on purchased leads list 133. After a lead is purchased, a credit is removed from the lead package associated with the user's account. In addition, the lead generation system may allow a user to preview, view and/or purchase another lead only after a certain amount of time has elapsed, e.g., 10, 20, 30, 40 or 50 seconds or between about 1 and about 5 minutes. Requiring that a predetermined period of time elapse between lead previews, views and/or purchases, provides all system users with an equal chance to review and purchase leads.

In further implementations, customer leads may expire after a predetermined period of time. For example, a customer lead that may be disseminated to a user up to 5 times may be inactivated on lead generation system 100 after 1, 2, 3, 4, 5 or 6 days, 1 or 2 weeks, or 1 month if the lead has not been purchased 5 times prior to the expiration date.

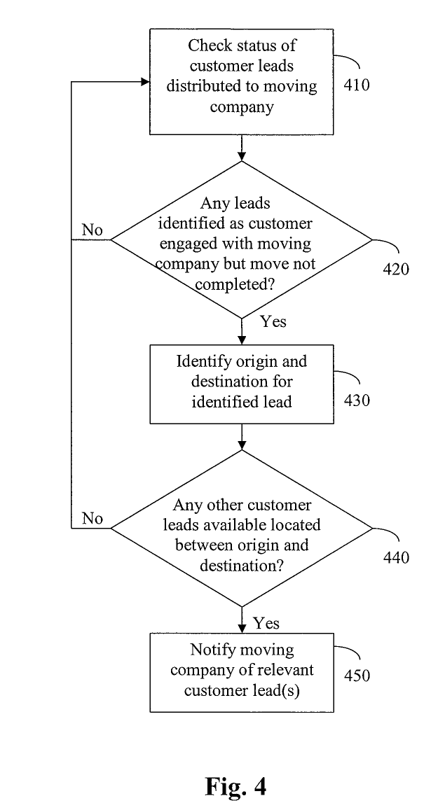

FIG. 4 is a flowchart depicting another aspect of a method of operation of the lead generation system. According to FIG. 4, once a user has purchased leads, the lead generation system may check (410) the status of the purchased leads to determine if any are identified (420) as having the customer engaged with moving company but the move not completed, e.g., a contract has been entered into between the parties but the moving company has not started the process of moving household items for the customer. If leads are identified (420), the lead origin and destination are also identified (430) and a determination (440) of whether any other customer leads are situated between the move origin and destination. Matching leads may be flagged and the moving company may be notified (450) of the relevant lead(s) and the initial lead that caused it to be a qualifying lead. The method of FIG. 3 may provide a moving company with leads it may not have otherwise purchased. In addition, the moving company may competitively bid on the flagged lead(s) because of each lead's location on a preplanned route. However, for some leads, an entire truckload may be required so that the truck may not take additional goods, and in such instances, the lead generation system may filter out the non-qualifying leads so that the method of FIG. 3 is not executed.

According to further implementations, a user account may receive news letters to inform the users of important news and events. In addition, a user account may receive bulk emails that may relate to for example, certain issues associated with their account, a change in the terms and conditions of use for the lead generation system, or other relevant information. A user may also have the ability to interact with lead generation system specialists in order to have questions answered, e.g., regarding their package, purchases or other services. Each user account may automatically log and store information relating to lead generation system access and interaction for future review and reference.

The lead generation system of the present invention provides several advantages to both moving companies and to customers. For example, because in certain embodiments customer leads are provided to a limited number of moving companies, a customer will not be overwhelmed with sales calls. In addition, the lead generation system matches profiles of the moving company with the needs of the customer, and thus only moving companies with requisite capabilities will be provided with lead information and be able to contact the customer. Further, moving companies are aware that a particular lead is or will be disseminated to other moving companies and thus a customer may benefit by competitive bidding between moving companies. Moreover, industry experts with knowledge of moving jobs and customer needs are provided leads as opposed to customers being provided leads. As a result, moving companies with knowledge of a customer's move (e.g., from detailed lead data) may provide immediate expert assistance to customers.

The method and system according to the present invention may be implemented using various combinations of software and hardware as would be apparent to those of skill in the art and as desired by the user. The present invention may be implemented in conjunction with a general purpose or dedicated computer system having computer system hardware components, including at least one processor operating according to one or more software modules configured to generate moving leads.

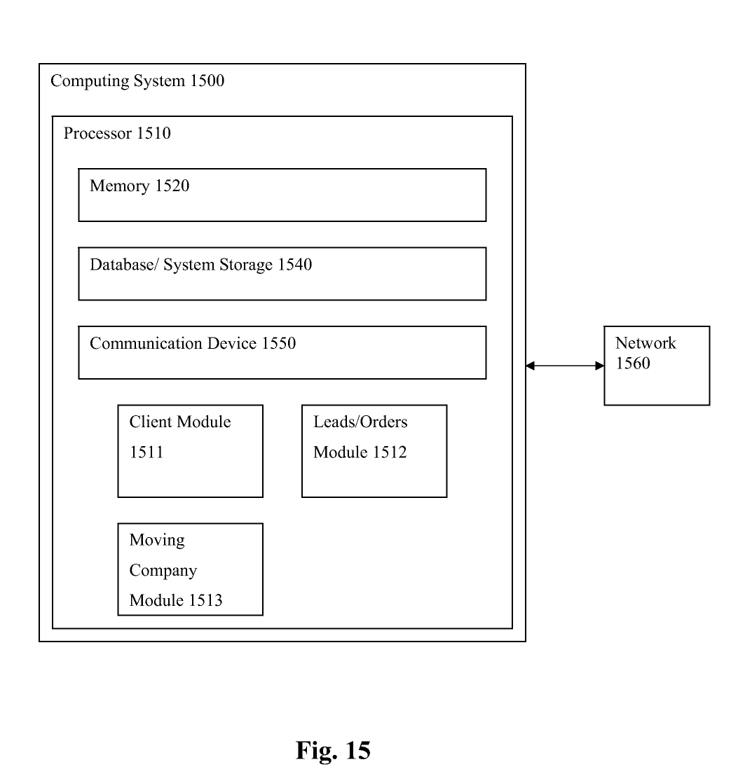

FIG. 15 is an exemplary computing system for implementing the lead generator described in the embodiments above. Computing system 1500 includes a number of components operably coupled and includes one or more processors 1510 having at least one customer module 1511, a leads/orders module 1412, and a moving company module 1413, memory 1520, database/system storage 1540, and communication device 1550 for accessing network 1560. Computing system 1500 may be communicatively coupled to or incorporated with database management system 140. Computing system 1500, and in particular, processor 1510, may be configured to be accessible by customers, moving companies (users), and system administrators and data entered into computing system 1500 may be processed by database management system 140, for example.

When accessible by a customer, processor 1510 may be configured to receive and process customer-entered moving data, preference data, customer profile data, service request data and other customer-related data via client module 1511. In addition, processor 1510 may be further configured to receive and process lead data and order data via leads/orders module 1512 so that leads information, such as a lead previews, may be accessed by users. When accessible by a user such as a moving company, processor 1510 may be configured to receive and process user-entered moving company data, such as moving capabilities and origination and destination locations, via moving company module 1513. Thus, modules 1511-1513 may implement all or a portion of the lead generator described in relation to FIGS. 1-14 above.

According to further embodiments, the insurance product may be modifiable by updating computing system 1500. The various modules 1511-1514 of processor 1510 may be configured to be modifiable so that changes in, for example, customer or moving company data or in lead/order status, may be automatically updated in computing system 1500. In certain implementations, the modules are modifiable via administrator panel 150. As a result, modules 1511-1513 may be configured to implement business rules, and changes or updates to the business rules may modify the operation of the computer implemented lead generation product.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A method for providing a moving and transportation lead to a moving and transportation company in a communications network comprising:
receiving customer data from a customer interface coupled to the communications network, said data comprising information related to a request for moving services;
matching the customer data with moving and transport service capabilities stored in a user profile in a computer accessible memory;
providing notification to a user account having the associated matching data of a customer lead.

2. The method of claim 1, wherein providing notification to the user account comprises providing an electronic mail alert message of the customer lead.

3. The method of claim 1, wherein providing notification to the user account comprises displaying a message about the customer lead on a user account page upon user log on.

4. The method of claim 1, further comprising providing a preview of the customer lead data.

5. The method of claim 4, wherein providing the preview of the customer lead data comprises providing customer location data.

6. The method of claim 4, wherein providing the preview of the customer lead data comprises customer destination data.

7. The method of claim 4, further comprising processing a request to purchase the customer lead, wherein processing comprises:
crediting a user account for the purchased customer lead; and
providing a detailed customer lead to the user account.

8. The method of claim 7, further comprising setting the status of the customer lead as inactive after providing the detailed customer lead to a predetermined number of user accounts.

9. A computer system for providing a moving and transportation lead to a moving and transportation company comprising:
a customer database for receiving and storing customer data from a customer interface coupled to a communication network, said data comprising information related to a request for moving services;
a user database coupled to the communication network for receiving and storing user profile data;
a database management system coupled to the communication network for comparing and matching the customer data with moving and transport service capabilities stored in the user profile; and
a leads/orders database coupled to the communication network for receiving and storing customer lead data and for providing notification to a user account having the associated matching data of a customer lead.

10. The computer system of claim 9, where the leads/orders database is configured to modify the stored lead data in response to receiving customer data related to a guarantee of moving services to a moving company.

11. The computer system of claim 10, wherein the user database comprises stored user profile data for the moving company.
